(19) United States
(12) Patent Application Publication
(10) Pub. No.: US 2016/0085383 A1
(43) Pub. Date: Mar. 24, 2016

(54) DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heege, Kaisersesch (DE); Wolfgang Mahnke, Hettenleidelheim (DE); Marko Schlueter, Espelkamp (DE)

(21) Appl. No.: 14/857,832

(22) Filed: Sep. 18, 2015

(30) Foreign Application Priority Data
Sep. 19, 2014 (DE) 10 2014 013 944.1

(51) Int. Cl. G06F 3/0481; H04L 12/24; G06F 3/0484

(52) U.S. Cl. CPC G06F 3/0481; G06F 3/04847; H04L 41/22; H04L 41/0806

(57) ABSTRACT

A device for managing and configuring field devices in an automation installation with a configuration tool that is designed to physically detect a field device in the automation installation, to logically incorporate it into the automation installation and to configure it in the automation installation, the configuration tool resorting for this purpose to a prescribed first field-device-specific information packet that describes the functions and data of the field device at least in part. In order to alter the size of windows in the relationship context, the windows in a relationship context being arranged in matrix form, directly adjacently, with the window boundaries forming a lattice structure of intersecting window boundary lines, each node of the intersecting window boundary lines has an associated operator control element, the operator control element has a control area, and activation of an operator control element renders the window boundary lines intersecting at this node relocatable.

### CROSS-REFERENCE TO RELATED APPLICATIONS

Priority is claimed to German Patent Application No. DE 10 2014 013 944.1, filed on Sep. 19, 2014, the entire disclosure of which is hereby incorporated by reference herein.

### FIELD

The invention relates to a device for managing and configuring field devices in an automation installation. The invention is used, in particular, in process automation or machine control for controlling processes and/or installation components.

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition June 2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

Known EDD host systems either restrict the number of windows or open an arbitrary number of windows for the different devices. This causes the user to lose track of the assignment of the windows to the devices.

In addition, the EDD specification allows an input context to be defined, which input context comprises changes to a device configuration which have already been made by the user at the interface but have not yet been written to the device or the offline configuration. According to the specification, it is possible in this case for different windows and dialogs to work on different input contexts of the same device.

According to the prior art, EDD host systems display the windows described in the EDD as windows of the application, with the result that the user can compare a plurality of window contents with one another.

A screen element, HMI device, automation system and computer program product for visualizing and projecting user texts which are used once and more than once and the associated points of use in a data processing system are known from DE 102 45 890 B4. What can be gathered from the disclosure is that the devices are provided for selection in a hierarchical tree structure, wherein a user text is associated with each branch which branches further and a combination of a user text and a point of use is associated with each branch which does not branch further. Details relating to a device are stored in nested menu levels. Hence, the operation and, in particular, the search for details relating to a device becomes a time-consuming process.

Known user programs, as well as configuration tools, display information to the user in different views. In this context, the user can have the desired information displayed in a window by using a menu. Alternatively, it is possible for different windows to be placed and displayed on the screen so that the user can see the information simultaneously and without changing the view.

In a display with a multiplicity of open windows on the screen, the individual windows have less space available on the screen area as the number of windows grows. Consequently, the window size becomes smaller or the windows are displayed in overlapping fashion. In both cases, the information to be shown is displayed at least incompletely. In the case of overlapping windows, the content of the overlapped window is concealed almost completely.

Although it is possible for the size of each window to be individually matched to requirements, this adjustment always entails changes for the visible regions of other windows. Particularly in the case of windows whose contents are in a relationship context with respect to another, individual adjustment of the window sizes is very time-consuming and is perceived as laborious and irritating by users.

### SUMMARY

An aspect of the invention provides a device for managing and configuring a field device in an automation installation, the device comprising: a configuration tool designed to physically detect the field device in the automation installation, to logically incorporate the field device into the automation installation, and to configure the field device in the automation installation, wherein the configuration tool indicates functions and data of each field device in one or more windows and holds the functions and/or data for editing, wherein the windows in a relationship context are arranged in matrix form, directly adjacently, with window boundaries forming a lattice structure of intersecting window boundary lines, wherein each node of the intersecting window boundary lines includes an associated operator control element, wherein the operator control element includes a control area, and wherein activation of an operator control element renders the window boundary lines intersecting at this node relocatable.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a basic illustration of windows in a relationship context in the initial state

FIG. 2 shows a basic illustration of windows in a relationship context following alteration of the window sizes

### DETAILED DESCRIPTION

An aspect of the invention relates to a device for managing and configuring field devices in an automation installation, which can be used, in particular, in process automation or machine control for controlling processes and/or installation components.

An aspect of the invention provides a device for managing and configuring field devices in an automation installation in which the size of windows can be altered in a simple manner in the relationship context.

An aspect of the invention provides a device for managing and configuring field devices in an automation installation with a configuration tool that is designed to physically detect a field device in the automation installation, to logically incorporate it into the automation installation and to configure it in the automation installation, the configuration tool indicating the functions and data of each field device in windows and holding them for editing.

According to an aspect of the invention, the windows in a relationship context are arranged in matrix form, directly adjacently, with the window boundaries forming a lattice structure of crossing window boundary lines. The nodes of the intersecting window boundary lines are in the form of operator control elements, activation of which renders the window boundary lines intersecting at this node relocatable. To this end, the operator control elements have a control area.

Relocation of the window boundary lines intersecting at a selected node changes the window size of all the windows in a relationship context in those rows and columns of the window matrix that adjoin the selected node. Advantageously, overlapping of windows in a relationship context is avoided in this case.

Selection of a suitable node means that the window sizes of the windows in a relationship context can be chosen such that the contents of windows in an editing context are fully visible.

According to a further feature of the invention, the control area of the operator control element is highlighted in form. Advantageously, the effect achieved by this is that the operator control element is discernible and is perceived even in the case of frameless windows.

According to a further feature of the invention, the control area of the operator control element is highlighted in color. Advantageously, the effect achieved by this is that the operator control element is discernible and is perceived even in the case of frameless windows.

Of particular advantage to perception in this case is the combination of color highlighting and formal highlighting.

According to a further feature of the invention, the relationship context comprises all the functions, data, graphical representations and/or operator control elements of a field device.

According to a further feature of the invention, the relationship context comprises all the displays for the selection of a field device.

### T

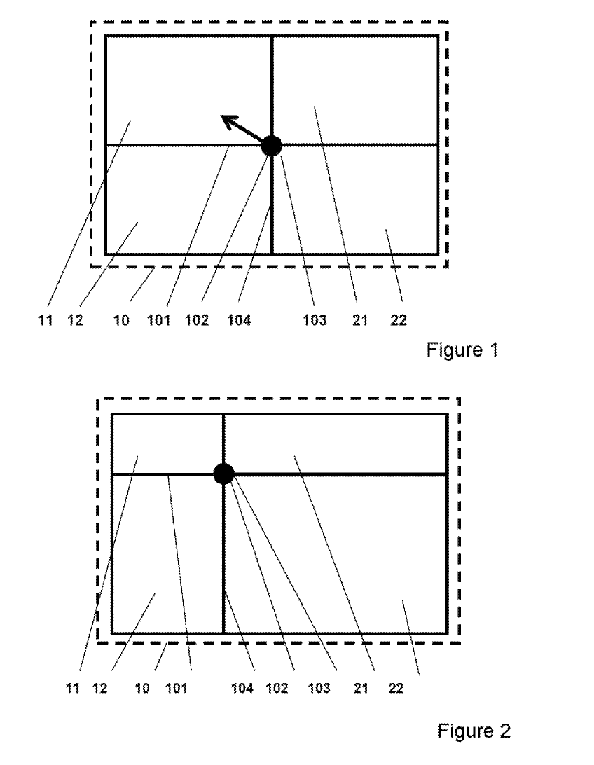

FIG. 1 is a basic illustration of a window display in a relationship context 10 in the configuration tool. Such a relationship context 10 comprises all the functions, data, graphical representations and/or operator control elements of a field device that are displayed in a plurality of windows 11 to 22.

In an extremely simple embodiment, the relationship context 10 comprises precisely four windows 11 to 22 that are arranged in matrix form, directly adjacently. The boundaries of adjacent windows 11 to 22 form a lattice structure of intersecting window boundary lines 101 and 104. The nodes 102 of the intersecting window boundary lines 101 and 104 are in the form of operator control elements 103. The operator control elements 103 have a control area. FIG. 1 shows a circular control area that concentrically surrounds the node 102 and highlights the operator control element 103 between the windows 11 to 22.

In the initial state shown in FIG. 1, all the windows 11 to 22 are of the same size. Activation of the operator control element 103 renders the window boundary lines 101 and 104 intersecting at this node 102 relocatable. In order to enlarge the area of the window 22, the operator control element 103 is activated and relocated in the direction of the arrow to inside the window 11. The operator control element 103 can be activated by means of gestures, pointing instruments and/or a keypad of the configuration tool.

The result of the relocation is shown in FIG. 2 using the same reference symbols for the same means. The window boundary line 104 has been relocated in the direction of the windows 11 and 12, while the window boundary line 101 has been relocated in the direction of the windows 11 and 21. The area of the window 22 has been enlarged, while the areas of the windows 11, 12 and 21 have been reduced. However, overlapping of windows 11 to 22 in the relationship context 10 is avoided in this case. All the windows 11 to 22 are visible.

The invention is not limited to relationship contexts 10 having only for windows 11 to 22 in two rows and two columns. On the contrary, a multiplicity of rows and columns are possible, depending on the display area of the configuration tool, all the nodes 102 of intersecting window boundary lines 101 and 104 each being equipped with an operator control element 103. The window boundary lines 101 and 104 do not need to be visibly highlighted in this case. On the contrary, the visible highlighting of the operator control elements 103 is adequate.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

10 relationship context
11 to 22 window
101, 104 window boundary line
102 node
103 operator control element

1. A device for managing and configuring a field device in an automation installation, the device comprising:
a configuration tool designed to physically detect the field device in the automation installation, to logically incorporate the field device into the automation installation, and to configure the field device in the automation installation,
wherein the configuration tool indicates functions and data of each field device in a plurality of windows and holds the functions and/or data for editing,
wherein the windows in a relationship context are arranged in matrix form, directly adjacently, with window boundaries forming a lattice structure of intersecting window boundary lines,
wherein each node of the intersecting window boundary lines includes an associated operator control element,
wherein the operator control element includes a control area, and
wherein activation of an operator control element renders the window boundary lines intersecting at this node relocatable.

2. The device of claim 1, wherein the control area of the operator control element is highlighted in form.

3. The device of claim 1, wherein the control area of the operator control element is highlighted in color.

4. The device of claim 2, wherein the control area of the operator control element is highlighted in color.

5. The device of claim 1, wherein the relationship context includes all functions, data, graphical representations, and/or operator control elements of the field device.

6. The device of claim 1, wherein the relationship context includes all functions, data, graphical representations, and/or operator control elements of the field device.

7. The device of claim 1, wherein the relationship context includes all functions of the field device.

8. The device of claim 1, wherein the relationship context includes all data of the field device.

9. The device of claim 1, wherein the relationship context includes all graphical representations of the field device.

10. The device of claim 1, wherein the relationship context includes all operator control elements of the field device.

11. The device of claim 1, wherein the relationship context includes all functions, data, graphical representations, and operator control elements of the field device.
